(19) United States
(12) Patent Application Publication
(10) Pub. No.: US 2021/0221138 A1
(43) Pub. Date: Jul. 22, 2021

(54) WIPING DEVICE, RECORDING APPARATUS, AND METHOD OF WIPING EJECTION PORT SURFACE

(71) Applicant: CANON KABUSHIKI KAISHA, Tokyo (JP)

(72) Inventors: Shin Genta, Kanagawa (JP); Toshimitsu Danzuka, Tokyo (JP); Masataka Kato, Kanagawa (JP); Kazuki Narumi, Tokyo (JP); Tomoki Yamamuro, Kanagawa (JP); Hiroto Kango, Tokyo (JP); Kazuhiko Sato, Tokyo (JP); Kazuo Suzuki, Kanagawa (JP)

(21) Appl. No.: 17/143,056

(22) Filed: Jan. 6, 2021

(30) Foreign Application Priority Data
Jan. 21, 2020 (JP) 2020-007823

(51) Int. Cl. B41J 2/165; B41J 2/045

(52) U.S. Cl. CPC B41J 2/16535; B41J 2002/16558; B41J 2/16552; B41J 2/04501

(57) ABSTRACT

A wiping device includes a cleaning member and a control unit. The cleaning member performs wiping operation to wipe an ejection port surface of a recording head. The recording head includes the ejection port surface on which an ejection port, for ejecting ink containing particles of a coloring material, is formed. The control unit controls the cleaning member to perform the wiping operation in a state where particles are imparted to a surface of the cleaning member. The imparted particles are different in type from the coloring material particles and each imparted particle has a particle diameter greater than a diameter of each of the coloring material particles.

### BACKGROUND

### Field

The present disclosure relates to a wiping device, a recording apparatus, and a method of wiping an ejection port surface.

### Description of the Related Art

An inkjet recording apparatus is required to cause ejected ink droplets to land on desired positions to generate an excellent recording image. If ink or dust adheres to an ejection port surface of a recording head, normal ejection may be inhibited. U.S. Pat. No. 8,342,638 discusses wiping operation performed while a web is pressed against the ejection port surface, thereby cleaning the ejection port surface. U.S. Pat. No. 8,342,638 further discusses a technique to impregnate the web with polyethylene glycol (PEG) for cleaning performance improvement.

In the technique discussed in U.S. Pat. No. 8,342,638, the web is impregnated with 60 g/m² to 90 g/m² of PEG. A PEG having a relatively low molecular weight of 400 or less is in a liquid state. In contrast, a PEG having relatively high molecular weight of 600 or more is in a solid state at room temperature. U.S. Pat. No. 8,342,638 discusses that the web can be impregnated with a PEG, such as PEG300 and PEG400, which is in a liquid state and has a low molecular weight.

### SUMMARY

An ink, such as pigment ink used in an inkjet recording apparatus, contains fine particles of a coloring material, such as pigment. The fine particles are dispersed into the ink without dissolving. The diameter of each of the particles of the pigment coloring material is about 20 to 30 nm. In wiping operation, if the coloring material in the ink adheres to a surface of a cleaning member and the ejection port surface is wiped by the cleaning member in this state, the wiping is performed in a state where the coloring material is in contact with the ejection port surface. At this time, PEG impregnated in the cleaning member is smaller in particle diameter than the coloring material since the PEG is in a liquid state. Depending on a material of the ejection port surface, the fine particles of the coloring material therefore may function as abrasive grains to shave the ejection port surface, and ejection performance may be deteriorated.

The present disclosure is directed to prevention of deterioration of the ejection port surface caused by the wiping operation of the ejection port surface with the cleaning member.

According to an aspect of the present disclosure, a wiping device includes a cleaning member configured to perform wiping operation to wipe an ejection port surface of a recording head, wherein the recording head includes the ejection port surface on which an ejection port, for ejecting ink containing particles of a coloring material, is formed, and a control unit configured to control the cleaning member to perform the wiping operation in a state where particles are imparted to a surface of the cleaning member, wherein the imparted particles are different in type from the coloring material particles and each imparted particle has a particle diameter greater than a diameter of each of the coloring material particles.

Further features of the present disclosure will become apparent from the following description of exemplary embodiments with reference to the attached drawings.

### BRIEF DESCRIPTION OF THE DRAWINGS

FIG. 1 illustrates a perspective view of an entire recording apparatus according to a first exemplary embodiment.

FIG. 2 illustrates a perspective view of an internal configuration of the recording apparatus according to the first exemplary embodiment.

FIG. 3 is a schematic block diagram illustrating an example of a control configuration of a recording apparatus according to the first exemplary embodiment.

FIG. 4 is a perspective view of a recording head according to the first exemplary embodiment.

FIG. 5 illustrates a positional relationship of the recording head, a wiping unit, and a recovery unit according to the first exemplary embodiment.

FIG. 6 is a cross-sectional view of a wiping unit according to the first exemplary embodiment.

FIG. 7 is a cross-sectional view of a wiping unit according to the first exemplary embodiment.

FIGS. 8A to 8D are diagrams illustrating wiping operation according to the first exemplary embodiment.

FIG. 9 is a diagram illustrating a surface state of each of a cleaning member and the recording head in the wiping operation.

FIGS. 10A and 10B are diagrams illustrating a surface state of each of the cleaning member and the recording head in the wiping operation according to the first exemplary embodiment.

FIGS. 11A and 11B are cross-sectional views of a wiping unit according to a second exemplary embodiment.

FIGS. 12A to 12F are diagrams illustrating wiping operation according to the second exemplary embodiment.

FIG. 13 is a cross-sectional view of a wiping unit according to a third exemplary embodiment.

FIGS. 14A to 14C are diagrams illustrating wiping operation according to the third exemplary embodiment.

### DESCRIPTION OF THE EMBODIMENTS

A first exemplary embodiment of the present disclosure will now be described.

### <Main Body Configuration>

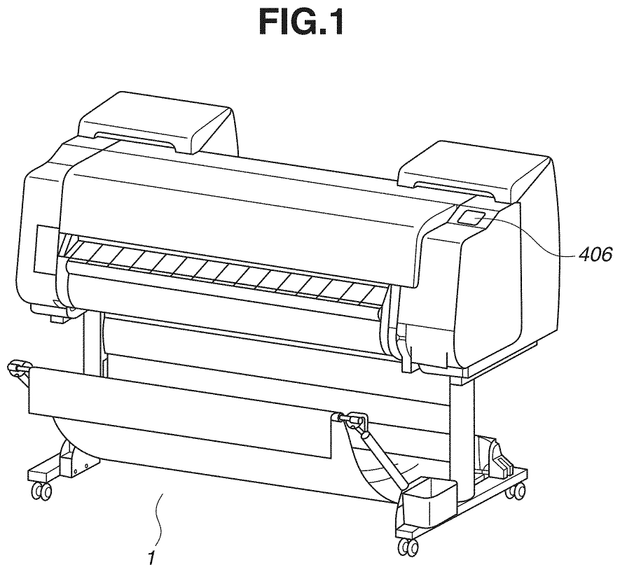

FIG. 1 illustrates a perspective view of an entire configuration of an inkjet recording apparatus 1 (hereinafter, also referred to as recording apparatus 1) according to the present exemplary embodiment. An operation panel 406 displays an ink remaining amount and candidate types of a recording medium on a display. A user can select a recording medium and perform recording setting by operating the operation panel 406.

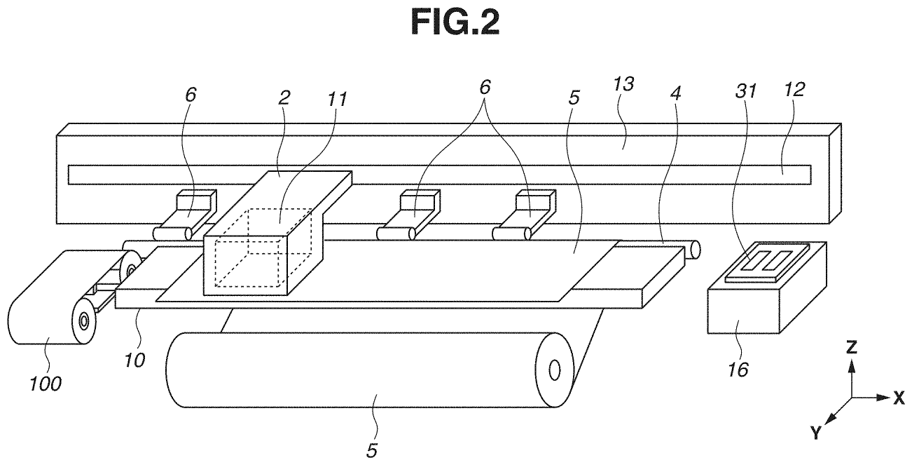

FIG. 2 is a perspective view of an internal configuration of the recording apparatus 1 illustrated in FIG. 1. As described in FIG. 2, the recording apparatus 1 includes a carriage guide 13, a carriage 2, a platen 10, a line feed (LF) roller 4, pinch rollers 6, a wiping unit 100, and a recovery unit 16.

The carriage guide 13 supports the carriage 2. More specifically, the carriage guide 13 movably supports the carriage 2 in a main scanning direction (X direction).

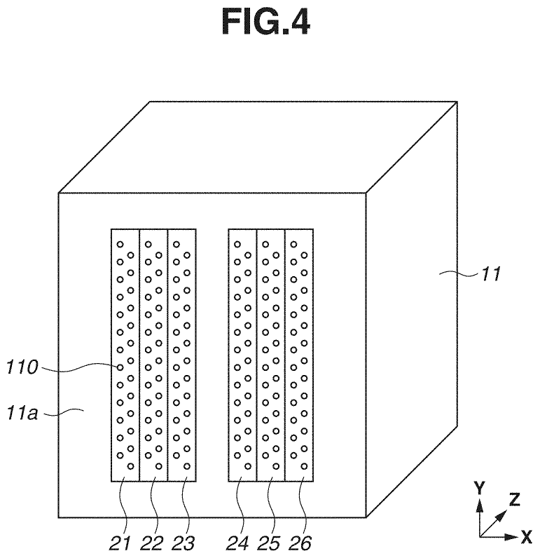

The carriage 2 performs reciprocal scanning in the X direction by rotation of a carriage motor (not illustrated) while being guided by a carriage rail 12. The carriage 2 is mounted with a recording head 11. The recording head 11 includes an ejection port surface 11a (illustrated in FIG. 4) on which ejection ports for ejecting ink are arranged. A configuration of the recording head 11 will be described below with reference to FIG. 4.

The platen 10 supports a recording medium 5 in an area where an image is formed by ejecting the ink from the recording head 11. On an upstream side of the platen 10 in a conveyance direction (Y direction), an LF roller 4 and pinch rollers 6 are provided to convey the recording medium 5.

In recording operation to record an image on the recording medium 5, the LF roller 4 and the pinch rollers 6 are driven with intermittent rotation of a conveyance motor (not illustrated). The recording medium 5 is thereby intermittently conveyed on the platen 10 in the Y direction. The carriage 2 is reciprocally scanned in the X direction while the recording medium 5 is stopped in the intermittent conveyance. During the reciprocal scanning, the ink of colors is ejected to the recording medium 5 from the ejection ports provided in the recording head 11 of the carriage 2, and the image and the like are recorded on the recording medium 5. After the intermittent conveyance of the recording medium 5 and ejection of the ink during the reciprocal scanning of the carriage 2 are repeated a predetermined number of times, recording of the image is completed, and the recording operation to the recording medium 5 ends.

In the present exemplary embodiment, a heater (not illustrated) is built in the platen 10. During the recording operation, the heater is driven, and the recording medium 5 is heated from a rear surface (surface on side opposite to surface where image, etc. are recorded) through the platen 10. When thermosetting ink is used, it is thereby possible to cure the ink ejected to the recording medium 5 by heating the ink immediately after the ink lands on the recording medium 5. Thus, the present exemplary embodiment makes it possible to fix the image and the like formed on the recording medium 5 even when the recording medium 5 is made of a nonabsorbable material, such as vinyl chloride.

A wiping unit 100 is provided at one of end in the X direction of a scanning area scanned by the carriage 2. The wiping unit 100 is a wiping mechanism including a cleaning member to wipe the ejection port surface 11a of the recording head 11. At the other end, the recovery unit 16 is provided. The recovery unit 16 includes a cap 31 that covers the ejection port surface 11a of the recording head 11 to prevent the ink near the ejection ports from drying.

### <Block Diagram>

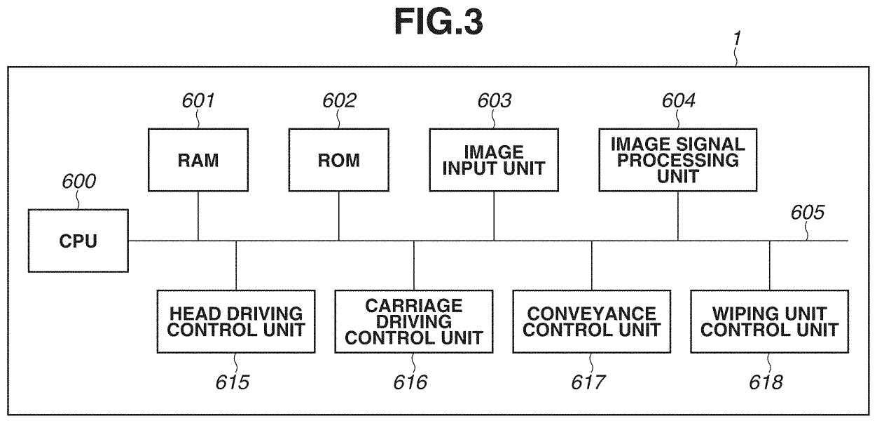

FIG. 3 is a schematic block diagram illustrating an example of a control configuration of the recording apparatus according to the present exemplary embodiment.

A central processing unit (CPU) 600 controls each of units described below via a main path line 605, and performs data processing. More specifically, the CPU 600 performs head driving control, a carriage driving control, and the data processing through units described below based on programs stored in a read only memory (ROM) 602.

A random access memory (RAM) 601 is used as a work area for the data processing and the like performed by the CPU 600. In place of the RAM 601, a storage device, such as a hard disk, may be used. An image input unit 603 includes an interface with a host computer (not illustrated), and temporarily holds an image input from the host computer. An image signal processing unit 604 performs various kinds of data processing to convert input image data into data to be recorded by the recording head 11.

A head driving control unit 615 controls driving of an ink ejection electrothermal converter of the recording head 11, and causes the recording head 11 to perform preliminary ejection and to eject the ink for recording. A carriage driving control unit 616 controls movement of the carriage 2 based on a program. Likewise, a conveyance control unit 617 controls, based on a program, a motor configured to drive the rollers, such as the LF roller 4 relating to conveyance of the recording medium. Likewise, a wiping unit control unit 618 controls the wiping unit 100 based on a program.

### <Head Configuration>

FIG. 4 is a schematic perspective view of the recording head 11 as viewed from −Z side. Ejection port arrays 21 to 26 in which ejection ports 110 are arranged are provided on the ejection port surface 11a. A material of the ejection port surface 11a in the present exemplary embodiment is a cured product of a resin. Alternatively, the ejection port surface 11a can be made of a metal, ceramics, or other materials. Further, an ejection port surface having water repellency or hydrophilicity can be used. Details of water repellency and hydrophilicity will be described below.

The recording head 11 according to the present exemplary embodiment is configured to eject yellow ink, magenta ink, cyan ink, black ink, light cyan ink, and light magenta ink. Each of the ejection port arrays 21 to 26 ejects each color of the inks. Each of the ejection port arrays 21 to 26 includes a plurality of ejection ports 110 arranged in the Y direction. In the present exemplary embodiment, centers of the ejection ports are at an interval of 1/1200 inches, and 1280 ejection ports 110 are arranged in the Y direction. In the present exemplary embodiment, the recording head 11 includes six ejection port arrays 21 to 26; however, the configuration is not limited thereto.

Each of the ejection ports 110 individually communicate with respective liquid paths (not illustrated). Each of the liquid paths includes an energy generation device generating ejection energy to eject ink from the corresponding ejection port 110. In the present exemplary embodiment, an electrothermal converter is used for the energy generation device. The electrothermal converter locally heats the ink to cause film boiling, and ejects the ink by pressure of the film boiling. In the following description, one ejection port 110 and one liquid path are collectively referred to as one nozzle. The ink is supplied to each of the ejection ports 110 of the recording head 11 from an ink tank (not illustrated) through a tube.

### <Water-Repellent Structure>

As described herein, water repellency may be imparted to the surface of the ejection port surface 11a. As an example to impart the water repellency, the ejection port surface can be made of a water-repellent negative epoxy resin (cationic polymerization). The water-repellent negative epoxy resin is typically obtained by previously mixing a silane water repellent containing a perfluoropolyether group, an organic acid, a fluorine solvent, and water. Alternatively, solution of partial hydrolysate obtained by partially hydrolyzing the silane water repellent containing a perfluoropolyether group can also be used as a material of a water-repellent film. The silane water repellent containing a perfluoropolyether group is partially hydrolyzed at a time of application. Thus, reactivity with a photosensitive resin layer is high, and the obtained water-repellent film has high water repellency.

### <Hydrophilic Structure>

Alternatively, hydrophilicity may be imparted to the surface of the ejection port surface 11a as described herein. As an example of a method of imparting hydrophilicity to the ejection port surface, a method using ultraviolet irradiation will now be described. When an ultraviolet ray (waveform of 185 nm) is applied to oxygen (O₂) in the atmosphere, ozone (O₃) is generated. When the ultraviolet ray (waveform of 254 nm) is absorbed by the ozone, the ozone is decomposed to generate active oxygen (O) in an excited state. The active oxygen reacts with a molecule whose molecular chain on the surface layer of the molecule is cleaved by the ultraviolet ray, and forms a new functional group (e.g., OH, CHO, and COOH) on the surface. These functional groups express hydrophilicity. Alternatively, other methods are used in some cases: discharge treatment (e.g., plasma treatment, corona treatment, and frame treatment), and surface oxidation by chemicals.

### <Ink Composition>

The ink used in the present exemplary embodiment will now be described. In the following, “part” and “%” are based on mass unless otherwise noted.

Color ink containing pigment and clear ink containing no or little pigment used in the present exemplary embodiment each contain a water-soluble organic solvent. The water-soluble organic solvent preferably has a boiling point of 150° C. or more and 300° C. or less in terms of wettability and moisture retaining property of a head orifice face. Further, a heterocyclic compound including a lactam structure is especially preferable in terms of a function of a film forming auxiliary to fine resin particles and swelling/solubility properties to the recording medium on which the resin layer is formed. The heterocyclic compound is represented by a ketone compound, a propylene glycol derivative, N-methyl-pyrrolidone, and 2-pyroolidone. In terms of ejection performance, a content of the water-soluble organic solvent is preferably 3 wt % or more and 30 wt % or less. Specific examples of the water-soluble organic solvent include: alkyl alcohols having 1 to 4 carbon atoms, such as methyl alcohol and ethyl alcohol; amides, such as dimethylformamide and dimethylacetamide; ketones or ketoalcohols, such as acetone and diacetone alcohol; ethers, such as tetrahydrofuran and dioxane; polyalkylene glycols, such as polyethylene glycol and polypropylene glycol; ethylene glycol or alkylene glycols whose alkylene groups have 2 to 6 carbon atoms; lower alkyl ether acetates, such as polyethylene glycol monomethyl ether acetate; glycerol; lower alkyl ethers of polyhydric alcohols, such as ethylene glycol monomethyl (or ethyl) ether; polyhydric alcohols, such as trimethylolpropane and trimethylolethane; and N-methyl-2-pyrrolidone, 2-pyrrolidone, and 1,3-dimethyl-2-imidazolidinone. The above-described water-soluble organic solvents can be used either singly or in any combination thereof. Deionized water is desirable for the water. The content of the water-soluble organic solvent contained in a reactant used in the exemplary embodiment of the present disclosure is not particularly limited. However, besides the above-described components, a surfactant, an antifoaming agent, a preservative, a mildew-proofing agent, and other components may be suitably added to the color ink and the clear ink used in the exemplary embodiment of the present disclosure as needed, to realize desired physical property values.

### <Wiping Unit and Recovery Unit>

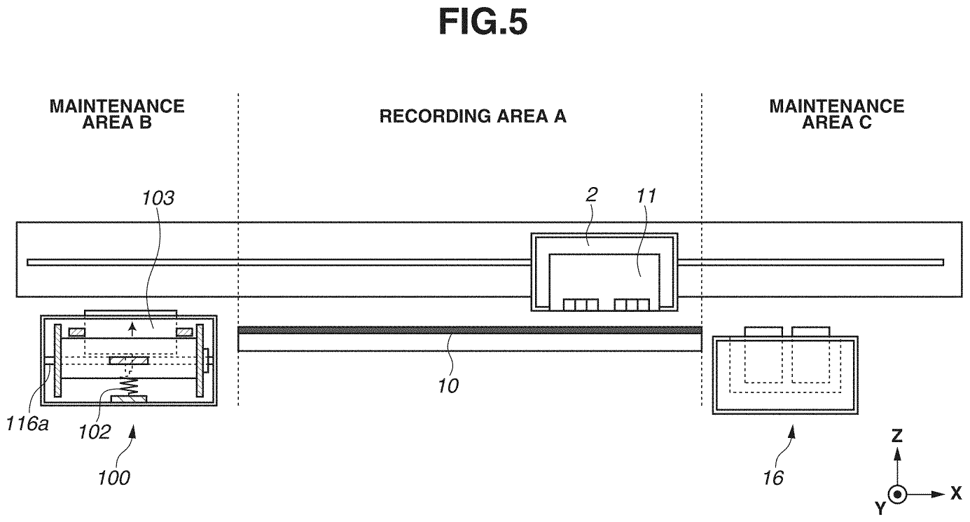

FIG. 5 is a schematic view of the internal configuration of the recording apparatus 1 as viewed from the Y direction. The wiping unit 100 and the recovery unit 16 are described below. The recovery unit 16 will now be described. A recording area A illustrated in FIG. 5 is an area where the recording medium 5 is supported by the platen 10, and recording is performed by the recording head 11. The recovery unit 16 is disposed in a maintenance area C adjacent to one end of the recording area A in the X direction. The recovery unit 16 includes a suction recovery mechanism, and an ascending/descending mechanism that elevates and lowers the suction recovery mechanism. The suction recovery mechanism includes the cap 31 that covers the ejection port surface 11a of the recording head 11, and a pump communicating with the cap 31. The suction recovery mechanism performs suction recovery processing. The suction recovery processing used herein indicates processing in which the ink is sucked from the plurality of nozzles provided in the recording head 11 to maintain the ink inside the nozzles to a state suitable for ejection. The pump generates negative pressure inside the cap 31, and the negative pressure forcibly sucks the ink from the ejection port surface 11a. The suction recovery mechanism is elevated and lowered by the ascending/descending mechanism (not illustrated), and is elevated to a position covering the ejection port surface 11a to perform the suction recovery processing.

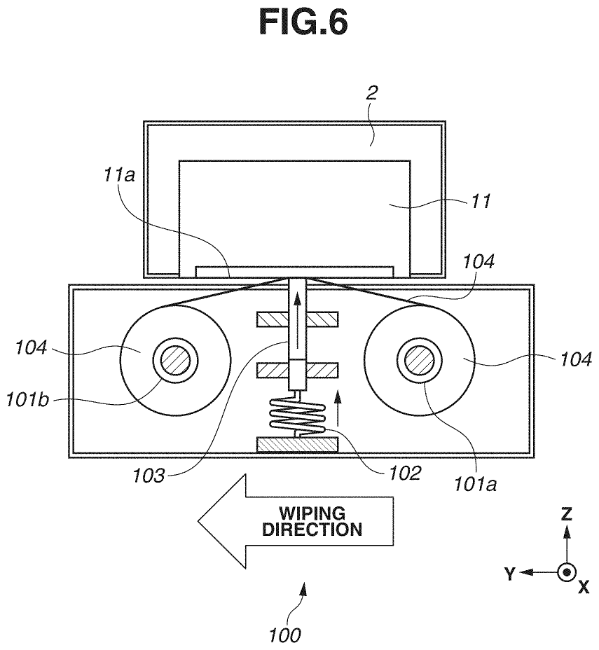

The wiping unit 100 that operates as a wiping device wiping the ejection port surface 11a of the recording head 11 will now be described. The wiping unit 100 is disposed in a maintenance area B adjacent to the recording area A in the X direction on a side opposite to the maintenance area C. FIG. 6 is a Y-Z cross-sectional view of the wiping unit 100. The wiping unit 100 includes a sheet-like cleaning member 104 that can wipe the ink adhering to the ejection port surface 11a of the recording head 11. An unused cleaning member 104 (before wiping ink) is wound around a first rotary member 101a. A second rotary member 101b is disposed on a downstream side of the first rotary member 101a in the conveyance direction (Y direction). A front end of the cleaning member 104 is attached to the second rotary member 101b. When the first rotary member 101a and the second rotary member 101b are rotated in a counterclockwise direction illustrated in FIG. 6, the used cleaning member 104 is wound up by the rotary member 101b. A pressing member 103 is disposed between the first rotary member 101a and the second rotary member 101b. The pressing member 103 pushes the cleaning member 104 upward (+Z direction) by a compression spring 102 at a constant load. The pressing member 103 pushes up the cleaning member 104 to a position where a part of the cleaning member 104 can come into contact with the ejection port surface 11a.

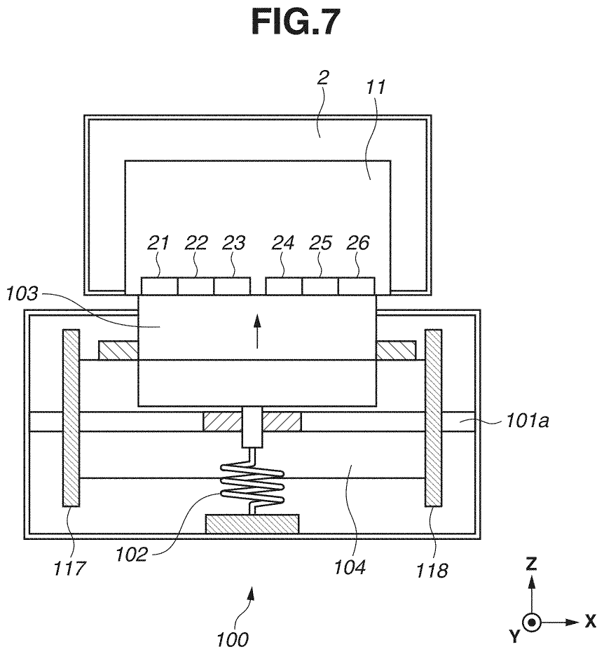

FIG. 7 is an X-Z cross-sectional view of the wiping unit 100. Each members are illustrated in a transparent manner. On both ends of the rotary members 101a and 101b, paired circular members 117 and 118 are provided. An outer diameter of the circular members 117 and 118 is greater than the maximum outer diameter when the cleaning member 104 is wound round the rotary members 101a and 101b.

### <Wiping Operation>

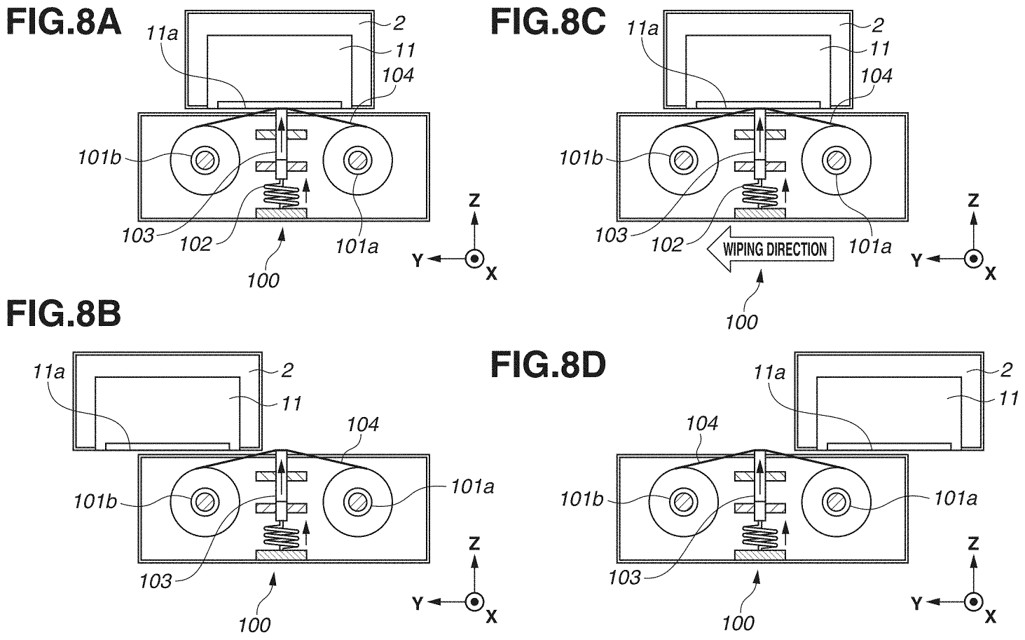

The wiping operation of the wiping unit 100 will now be described. FIGS. 8A to 8D are diagrams illustrating a flow of the wiping operation of the wiping unit 100.

FIG. 8A is a diagram illustrating a standby position when the wiping unit 100 does not perform the wiping operation. At this time, the recording head 11 is positioned in an area other than the maintenance area B.

FIG. 8B is a diagram illustrating a state where the carriage 2 moves from the recording area A to the maintenance area B to wipe the ejection port surface 11a, and the wiping unit 100 moves from the standby position to a retreat position to perform the wiping operation. In a case where the wiping unit 100 is positioned at the retreat position, the cleaning member 104 does not abut on the ejection port surface 11a of the recording head 11. In the state where the wiping unit 100 is positioned at the retreat position, the rotary members 101a and 101b are not rotated.

FIG. 8C is a diagram illustrating a state where the wiping unit 100 performs the wiping operation to wipe the ink adhering to the ejection port surface 11a of the recording head 11 with the cleaning member 104. The wiping unit 100 abuts on the ejection port surface 11a by moving in the +Y direction from the state illustrated in FIG. 8B, and wipes the ejection port surface 11a while further moving in the +Y direction.

FIG. 8D is a diagram illustrating a state where the cleaning member 104 has completed wiping the recording head. The state indicates a state where the wiping unit 100 further moves in the +Y direction from the state illustrated in FIG. 8C, and the cleaning member 104 is separated from the ejection port surface 11a of the recording head 11. At this time, the second rotary member 101b is rotated by a motor (not illustrated). When the second rotary member 101b rotates, the cleaning member 104 is wound up from the first rotary member 101a to the second rotary member 101b. Thus, a portion of the cleaning member 104 pushed up by the pressing member 103 is a portion not performing the wiping operation, and the portion is used in next wiping operation. As described above, the wiping operation is performed.

### <Configuration of Cleaning Member>

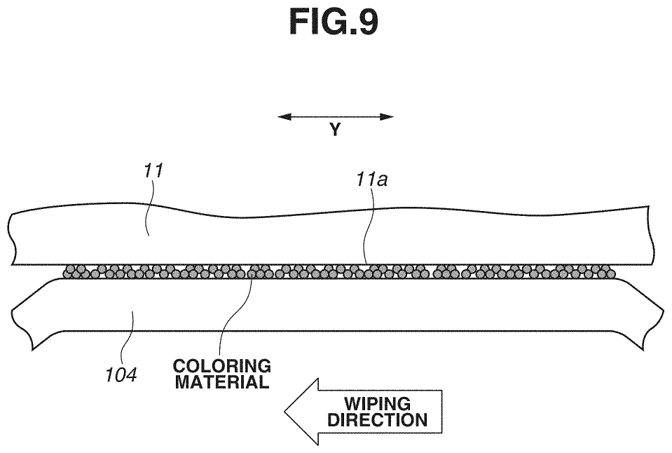

FIG. 9 is a diagram illustrating a state where the coloring material adhering to the surface of the cleaning member is dragged on the ejection port surface along with the wiping operation.

In the present exemplary embodiment, a diameter of the particles of the coloring material, such as pigment, contained in the pigment ink used in the inkjet recording apparatus 1 is about 20 to 30 nm. I contrast, the cleaning member 104 according to the present exemplary embodiment is a non-woven fabric. The non-woven fabric used herein is a sheet web or a pad-like fabric obtained by bonding or intertwining fibers through fusion, mechanical action, or chemical action. The ink adhering to the ejection port surface 11a is instantaneously absorbed in the cleaning member 104 along with the wiping operation by the capillary pressure of fine pores of the cleaning member 104. FIG. 9 illustrates a state at this time. As illustrated in FIG. 9, a part of the coloring material remains on the cleaning member 104. A fiber diameter of the cleaning member 104 is several μm, which is sufficiently larger than the diameter of each of the particles of the coloring material. Thus, a certain amount of the coloring material is absorbed together with the solvent to the cleaning member 104. However, a part of the coloring material remains on the surface of the cleaning member 104 by riding on the fibers of the cleaning member 104. When the wiping operation is continued in a state where the coloring material remains on the cleaning member 104, the coloring material adhering to the surface of the cleaning member 104 is dragged between the cleaning member 104 and the ejection port surface 11a. When the coloring material is dragged, the particles of the coloring material function as abrasive grains, and the ejection port surface 11a is shaved in a direction parallel to the wiping direction with a width substantially equal to the diameter of each of the particles of the coloring material of 20 to 30 nm, and is damaged. Such damage of the ejection port surface 11a leads to deterioration of ejection performance. For example, in a case where treatment to impart water repellency to the ejection port surface is performed, the water-repellent film is peeled, and the water repellency is lowered. When the water repellency is lowered, the ink remaining on the ejection port surface from wiping gets wet and spreads over an area where the water-repellent film is peeled. The ink ejected from the nozzles may be attracted to the wetting and spreading ink, and thus an ejection direction or an ejection amount may be changed or the ejection may not be performed.

In the present exemplary embodiment, the wiping operation is therefore performed in a state where particles each having a particle diameter greater than the diameter of each of the particles of the coloring material are applied on the cleaning member 104. In this example, as the particles each having the particle diameter greater than the diameter of each of the particles of the coloring material, fine resin particles are used. In the present exemplary embodiment, the cleaning member 104 is previously impregnated with the fine resin particles.

The “fine resin particles” according to the present exemplary embodiment are fine particles made of a resin and having a particle diameter dispersible to an aqueous medium. Specific examples of the resin forming the fine resin particles include: fine acrylic resin particles synthesized by emulsion polymerization of a monomer, such as alkyl (meth) acrylate and (meth) acrylic acid alkylamide; fine styrene-acrylic resin particles synthesized by emulsion polymerization of alkyl (meth) acrylate or (meth) acrylic acid alkylamide with a styrene monomer; and fine polyethylene resin particles, fine polypropylene resin particles, fine polyurethane resin particles, and fine styrene-butadiene resin particles. The examples further include, fine core-shell resin particles each including a core and a shell made of polymers having different compositions, and fine resin particles produced by emulsion polymerization using fine acrylic particles synthesized in advance as seeds for controlling the particle size. The examples further include fine hybrid resin particles produced by chemically bonding different types of fine resin particles, for example, fine acrylic resin particles and fine urethane resin particles. One or more types of fine resin particles can be impregnated.

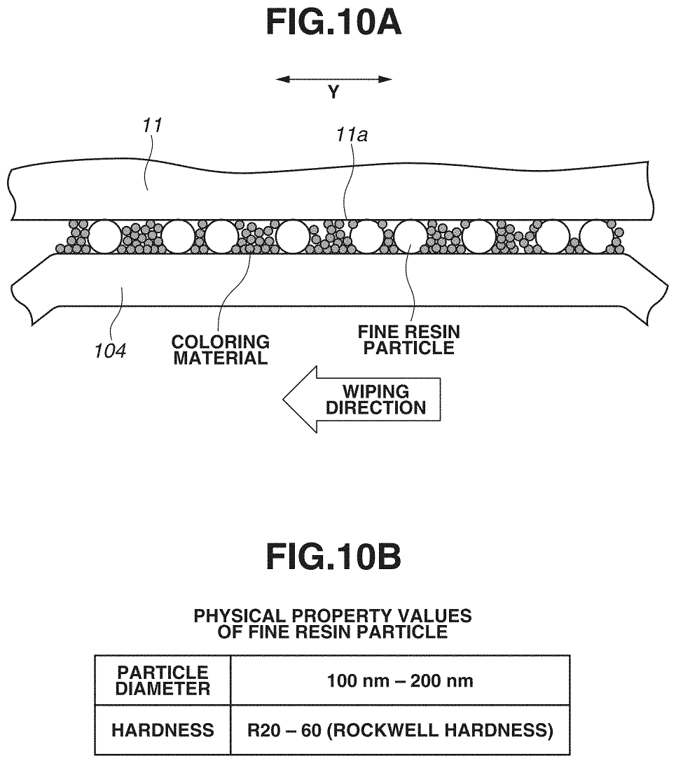

FIG. 10A is a diagram illustrating a state of the wiping operation in a case where the cleaning member 104 is impregnated with the fine resin particles according to the present exemplary embodiment. In the present exemplary embodiment, the cleaning member 104 is previously impregnated with the fine resin particles each having a particle diameter of 100 to 200 nm greater than the diameter of 20 to 30 nm of each of the particles of the coloring material contained in the ink, and being dispersed to a solution, such as ethylene glycol and water. Examples of the fine resin particles include the fine acrylic resin particles, the fine acrylic-styrene resin particles, the fine polyethylene resin particles, the fine polypropylene resin particles, the fine polyurethane resin particles, and the fine styrene-butadiene resin particles described above; however, the fine resin particles are not limited thereto.

As illustrated in FIG. 10A, in the case where the ejection port surface 11a is wiped, the ink adhering to the ejection port surface 11a is instantaneously absorbed to the cleaning member 104 along with the wiping operation, and a part of the coloring material remains on the surface of the cleaning member 104 as described with reference to FIG. 9. However, since the particle diameters of the fine resin particles are relatively greater than the particle diameters of the coloring material, the fine resin particles come into contact with the ejection port surface 11a in the wiping operation. Thus, the fine resin particles function as spacers and cushion materials, and therefore the coloring material is difficult to be dragged while being in contact with the ejection port surface 11a. The ejection port surface 11a is thereby difficult to be shaved by the wiping operation, preventing degradation of the ejection performance.

As described above, since the fine resin particles function as the spacers and the cushion materials, the wiping operation is performed in the state where the fine resin particles are in contact with the ejection port surface 11a as illustrated in FIG. 10A. Thus, the fine resin particles desirably have hardness lower than hardness of the material (e.g., epoxy resin) of the ejection port surface 11a of the recording head 11 and hardness of the coloring material (e.g., pigment particles) contained in the ink as illustrated in FIG. 10B. An area of the particles contacting with the ejection port surface 11a caused by crush of the particles receiving a load increases as the hardness of the particles becomes lower. The load per unit area is thereby lowered, which is advantageous or beneficial to shaving. As an example, the fine resin particles used in the present exemplary embodiment have hardness of about R20 to R60 in Rockwell hardness; however, the fine resin particles are not limited thereto. The Rockwell hardness is acquired from the following formula (1) by measuring indentation hardness with a Rockwell hardness testing machine:

HR=130−500h, (1)

where HR is Rockwell hardness, and h is actual depression depth (mm) when a reference load is defined as zero point.

A plastic material the material of the ejection port surface typically has hardness of about R70 to about R120. If the hardness of the fine resin particles is greater than or equal to R60, the hardness of the fine resin particles becomes substantially equivalent to the hardness of the ejection port surface 11a. Rubbing of the materials having the same hardness is disadvantageous to shaving. Further, when the hardness is less than R20, the crushed amount increases and the fine resin particles become crushed, which may bring the coloring material into contact with the ejection port surface 11a.

The particle diameter of each of the fine resin particles is not limited to the above-described particle diameter as long as the particle diameter is greater than the diameter of each of the particles of the coloring material. To further prevent the coloring material from coming into contact with the ejection port surface 11a during the wiping operation, the particle diameter of each of the fine resin particles is preferably five times or more of the diameter of each of the particles of the coloring material. Further, the hardness of the fine resin particles can be less than R20 as long as the fine resin particles have a size not bringing the coloring material into contact with the fine resin particles when the fine resin particles are crushed by the wiping operation.

With the above-described configuration, the fine resin particles function as the spacers and the cushion materials, even in the case where the ejection port surface 11a is wiped by the cleaning member 104, and therefore the coloring material is difficult to be dragged on the ejection port surface 11a, as illustrated in FIG. 10A. This makes it possible to prevent the surface of the ejection port surface 11a from being shaved. In particular, in the case where the surface treatment to impart water repellency or hydrophilicity to the ejection port surface is performed, the film having the water repellency or hydrophilicity becomes difficult to be shaved. This can prevent deterioration of the ink ejection performance and deterioration of image quality.

A second exemplary embodiment will now be described. The configuration other than the wiping unit is similar to the configuration described in the first exemplary embodiment. Thus, only the detail of the wiping unit will be described.

### <Wiping Unit>

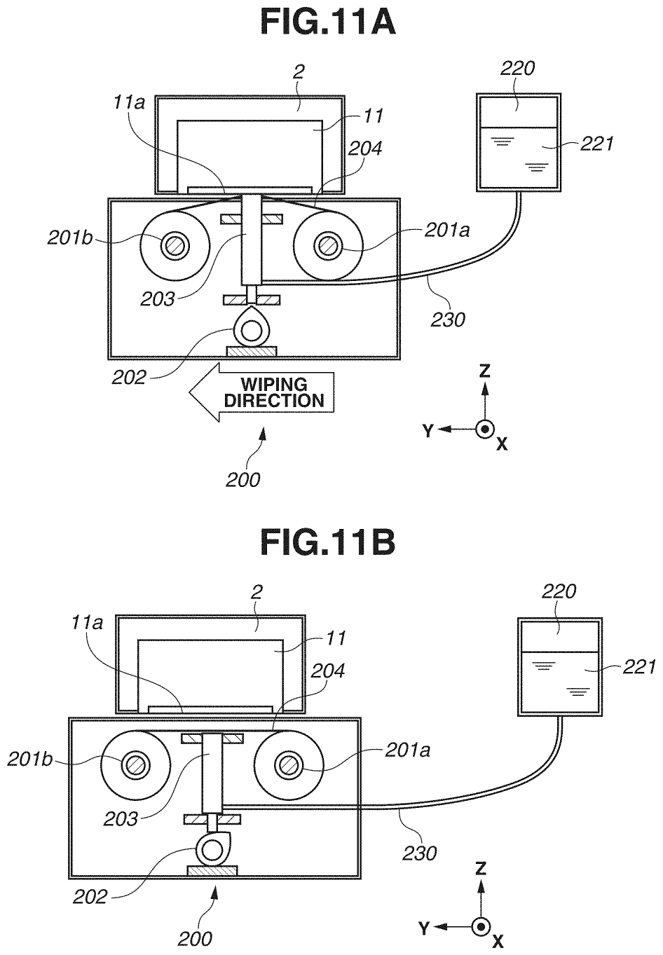

FIGS. 11A and 11B are Y-Z cross-sectional views of a wiping unit 200 according to the second exemplary embodiment. The wiping unit 200 illustrated in FIGS. 11A and 11B is disposed in the maintenance area B as with the wiping unit 100 according to the first exemplary embodiment. A cleaning member 204, a third rotary member 201a, and a fourth rotary member 201b are disposed in a manner similar to the cleaning member 104, the first rotary member 101a, and the second rotary member 101b according to the first exemplary embodiment. A used cleaning member 204 is wound up by the rotary member 201b.

The wiping unit 200 according to the present exemplary embodiment externally includes a fine-resin-particle supply tank 220. The fine-resin-particle supply tank 220 is disposed at a position higher than the wiping unit 200, and the fine-resin-particle supply tank 220 houses solution 221 in which a predetermined amount of fine resin particles described in the first exemplary embodiment is dispersed into an aqueous medium. Between the third rotary member 201a and the fourth rotary member 201b, a pressing member 203 made of a porous body and a cam 202 configured to elevate and lower the pressing member 203 are disposed. A motor (not illustrated) to rotate the cam 202 is disposed on a center axis of the cam 202. The pressing member 203 is movable in a vertical direction by own weight. The cleaning member 204 can take two positions illustrated in FIGS. 11A and 11B. As illustrated in FIG. 11A, the pressing member 203 comes into contact with the cleaning member 204, and the cleaning member 204 abuts on the ejection port surface 11a of the recording head 11 when the cam 202 rotates in the counterclockwise direction. As illustrated in FIG. 11B in contrast, when the cam 202 rotates in a clockwise direction from the state illustrated in FIG. 11A, the pressing member 203 is lowered, the cleaning member 204 is separated from the ejection port surface 11a of the recording head 11, and the pressing member 203 is also separated from the cleaning member 204.

The above-described fine-resin-particle supply tank 220 includes a supply flow path 230 to supply, to the porous pressing member 203, the solution 221 in which the fine resin particles are dispersed into the aqueous medium. The solution 221 is supplied from the fine-resin-particle supply tank 220 to the pressing member 203 through the supply flow path 230. Since the fine-resin-particle supply tank 220 is disposed at the position higher than the wiping unit 200, the solution 221 is successively supplied to the pressing member 203 by water head difference. Since the pressing member 203 is made of a porous body, the pressing member 203 absorbs the solution 221 up to an allowable holding range. The solution 221 does not leak from the pressing member 203. Unless the solution 221 is completely exhausted, the pressing member 203 constantly holds the solution 221, and the pressing member 203 is maintained moisturized with the solution 221, accordingly.

### <Wiping Operation>

The wiping operation of the wiping unit 200 according to the second exemplary embodiment will now be described.

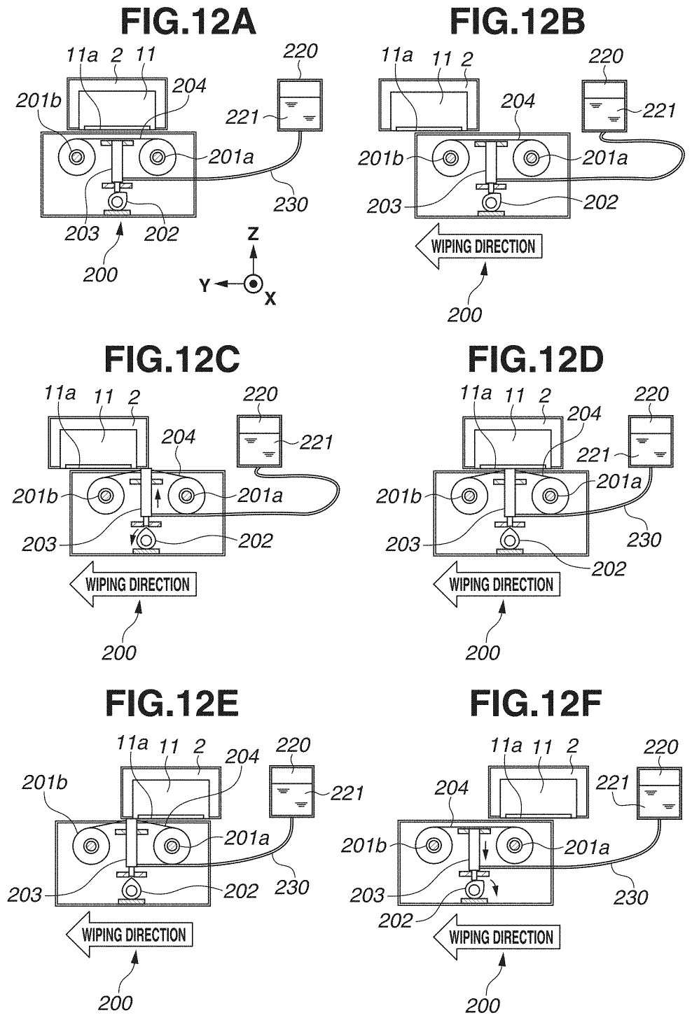

FIGS. 12A to 12F are diagrams illustrating a flow of the wiping operation of the wiping unit 200 according to the second exemplary embodiment. FIG. 12A is a diagram illustrating a standby position when the wiping unit 200 does not perform the wiping operation. At this time, the recording head 11 is positioned in an area other than the maintenance area B.

FIG. 12B is a diagram illustrating a state where the carriage 2 moves from the recording area A to the maintenance area B to wipe the ejection port surface 11a, and the wiping unit 200 moves from the standby position to a retreat position to perform the wiping operation. When the wiping unit 200 is positioned at the retreat position, the cleaning member 204 does not abut on the ejection port surface 11a of the recording head 11. The rotary members 201a and 201b are not rotated. The pressing member 203 is lowered as illustrated in FIG. 11B, and the cleaning member 204 does not abut on the recording head 11. The pressing member 203 and the cleaning member 204 are separated from each other.

FIG. 12C is a diagram illustrating a state where the wiping unit 200 performs the wiping operation. In this state, as illustrated in FIG. 11A, the cam 202 is rotated in the counterclockwise direction to push up the pressing member 203, and the cleaning member 204 accordingly wipes the ink adhering to the ejection port surface 11a of the recording head 11. At this time, the solution 221, in which the fine resin particles are dispersed in the aqueous medium, held by the pressing member 203 is absorbed by the capillary pressure of the cleaning member 204. The cleaning member 204 wipes the ejection port surface 11a while being impregnated with the solution 221. The wiping operation is performed when the wiping unit 200 moves in the +Y direction from the state illustrated in FIG. 12B.

FIG. 12D is a diagram illustrating a state in the middle of the wiping operation when the wiping unit 200 further moves in the +Y direction from the state illustrated in FIG. 12C.

FIG. 12E is a diagram illustrating a state where the cleaning member 204 has completed the wiping of the recording head 11.

FIG. 12F illustrates a state where the wiping ends, and the cleaning member 204 is separated from the recording head 11. When the cam 202 is rotated in the clockwise direction by a motor (not illustrated), the pressing member 203 is lowered, and is separated from the ejection port surface 11a and the cleaning member 204. In other words, since the pressing member 203 and the cleaning member 204 are separated from each other, supply of the solution 221 to the cleaning member 204 is stopped. This prevents the solution 221 from being supplied to the cleaning member 204 more than necessary, and suppresses consumption of the solution 221. In the state illustrated in FIG. 12F, the fourth rotary member 201b is rotated, and the cleaning member 204 is wound up from the third rotary member 201a to the fourth rotary member 201b.

In the above-described manner, it is possible to supply the solution 221 to the area of the cleaning member 204 abutting on the ejection port surface 11a at timing of the wiping operation.

A third exemplary embodiment will now be described. The configuration other than the wiping unit is similar to the configuration described in the first exemplary embodiment. Thus, only details of the wiping unit will be described.

### <Wiping Unit>

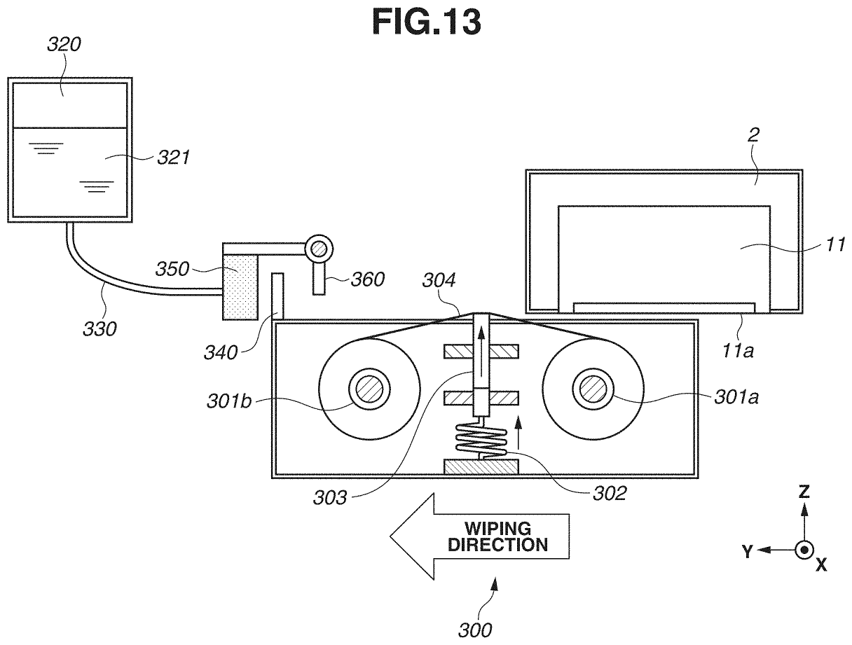

FIG. 13 is a Y-Z cross-sectional view of a wiping unit 300 according to the third exemplary embodiment. The wiping unit 300 illustrated in FIG. 13 is disposed in the maintenance area B as with the wiping unit 100 according to the first exemplary embodiment. A cleaning member 304, a fifth rotary member 301a, and a sixth rotary member 301b are disposed in a manner similar to the cleaning member 104, the first rotary member 101a, and the second rotary member 101b according to the first exemplary embodiment. Further, as members similar to the pressing member 103 and the compression spring 102 according to the first exemplary embodiment, a pressing member 303 and a compression spring 302 are disposed. A used cleaning member 304 is wound up from the rotary member 301a to the rotary member 301b.

The wiping unit 300 according to the present exemplary embodiment externally includes a fine-resin-particle tank 320. The fine-resin-particle tank 320 is disposed at a position higher than the wiping unit 300, and the fine-resin-particle tank 320 houses solution 321 in which a predetermined amount of fine resin particles described in the first exemplary embodiment is dispersed into an aqueous medium. The wiping unit 300 according to the present exemplary embodiment further includes a solution absorbing member 350 made of a porous body and disposed at a position lower than the fine-resin-particle tank 320. The fine-resin-particle tank 320 includes a supply flow path 330 to supply the solution 321 to the solution absorbing member 350. Since the fine-resin-particle tank 320 is disposed at the position higher than the solution absorbing member 350, the solution 321 is successively supplied to the solution absorbing member 350 by water head difference. Since the solution absorbing member 350 is made of a porous body, the solution absorbing member 350 absorbs the solution 321 up to an allowable holding range. The solution 321 does not leak from the solution absorbing member 350. Unless the solution 321 is completely exhausted, the solution absorbing member 350 holds the solution 321 inside the porous body and on a surface of the porous body.

At an upper end of the wiping unit 300 on the downstream side in the wiping direction, a transfer member 340 is provided. The transfer member 340 is configured to transfer the solution 321 to the ejection port surface 11a of the recording head 11. The transfer member 40 contains an elastic material, such as a rubber member. The transfer member 340 is disposed at a position in which the transfer member 340 rubs on the recording head 11 while abutting on the recording head 11, and a part of the transfer member 340 comes into contact with the ejection port surface 11a while being elastically deformed, in the wiping operation of the wiping unit 300. On the upstream side of the solution absorbing member 350 in the wiping direction, a scraper 360 is provided. The scraper 360 comes into contact with a part of the transfer member 340, to scrape foreign substances on the surface of the transfer member 340. The scraper 360 includes a resin member. The scraper 360 is provided to scrape foreign substances adhering to the transfer member 340 through the wiping operation.

### <Wiping Operation>

The wiping operation of the wiping unit 300 according to the third exemplary embodiment will now be described.

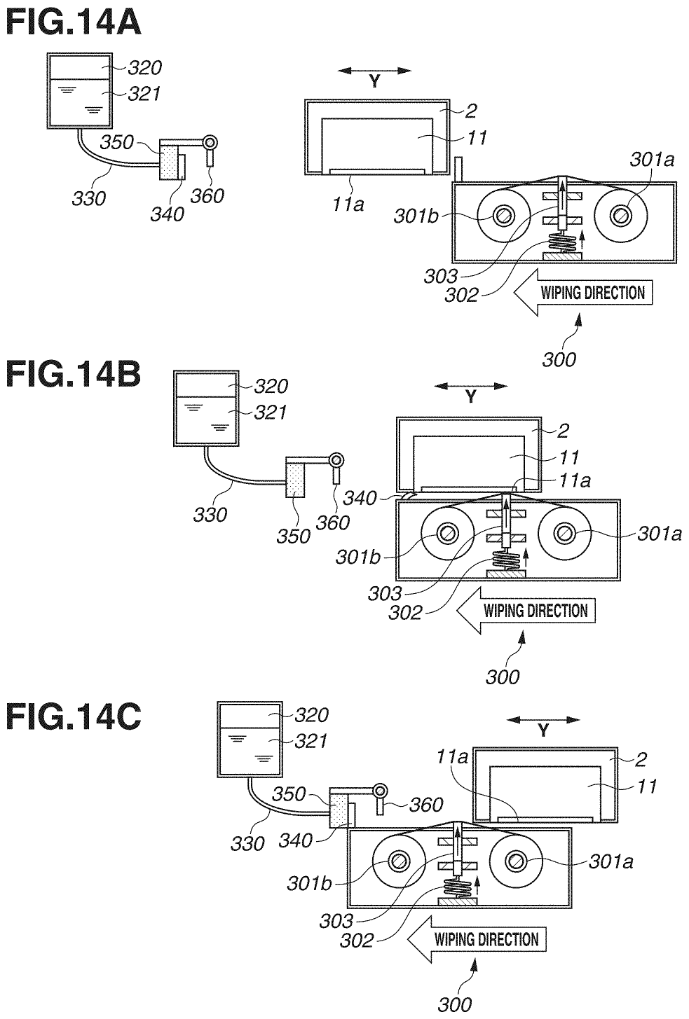

FIGS. 14A to 14C are diagrams illustrating a flow of the wiping operation performed by the wiping unit 300 according to the third exemplary embodiment.

When the wiping unit 300 does not perform the wiping operation, the recording head 11 stands by at a standby position in an area other than the maintenance area B.

FIG. 14A is a diagram illustrating a state where the carriage 2 moves from the recording area A to the maintenance area B to wipe the ejection port surface 11a, and the wiping unit 300 moves from the standby position to a retreat position to perform the wiping operation. In a case where the wiping unit 300 is positioned at the retreat position, the cleaning member 304 does not abut on the ejection port surface 11a of the recording head 11. The rotary members 301a and 301b are at rest. As described above, the transfer member 340 is provided at the upper end of the wiping unit 300 on the downstream side in the wiping direction. The transfer member 340 is configured to transfer the solution 321 to the ejection port surface 11a of the recording head 11. In the retreated state, the transfer member 340 is positioned at a position not abutting on the ejection port surface 11a.

FIG. 14B is a diagram illustrating a state where the wiping unit 300 performs the wiping operation. Since the transfer member 340 is disposed on the downstream side of the cleaning member 304 in the wiping direction, the transfer member 340 abuts on the ejection port surface 11a before the ejection port surface 11a is wiped by the cleaning member 304. The transfer member 340 transfers the solution 321 to the ejection port surface 11a of the recording head 11 by transferring the solution 321 from the fine-resin-particle tank 320 described below. The cleaning member 304 cleans the ejection port surface 11a by abutting on and wiping the ejection port surface 11a to which the solution 321 has been transferred.

FIG. 14C is a diagram illustrating a state where the cleaning member 304 has completed the wiping operation of the recording head 11. In this state, the transfer member 340 and the cleaning member 304 are separated from the recording head 11. After the transfer member 340 is separated from the recording head 11, the scraper 360 scrapes foreign substances on the surface of the transfer member 340 to clean the surface of the transfer member 340. Thereafter, the transfer member 340 abuts on the solution absorbing member 350. At this time, a part of the solution 321 held on the surface of the porous body of the solution absorbing member 350 is imparted to the transfer member 340. Examples of the foreign substances on the surface of the transfer member 340 include thickened ink adhering to the ejection port surface 11a, fibers of the cleaning member, and paper powder. In a case where the transfer member 340 abuts on the solution absorbing member 350 in a state where these foreign substances adhere to the transfer member 340, the solution 321 may not be sufficiently supplied to the transfer member 340, and a transfer amount of the solution may be gradually decreased. To prevent this, the surface of the transfer member 340 is scraped by the scraper 360 after the wiping operation. In the state illustrated in FIG. 14C, the sixth rotary member 301b is rotated by a motor (not illustrated), and the cleaning member 304 is wound up from the fifth rotary member 301a to the sixth rotary member 301b.

As described above, in the present exemplary embodiment, the cleaning member 304 wipes the ink after a predetermined amount of fine resin particles dispersed into the aqueous medium is transferred to the ejection port surface 11a. This makes it possible to wipe the ejection port surface 11a in a state where the predetermined amount of fine resin particles is present between the ejection port surface 11a and the cleaning member 304. At this time, the ejection port surface 11a is put into the state as illustrated in FIG. 10A, which makes it possible to prevent the ejection port surface 11a from being shaved.

In the recording apparatus 1 according to the above-describe exemplary embodiments, the wiping unit performs the wiping operation by moving in the Y direction; however, the wiping method is not limited thereto. It may be sufficient to perform the wiping by relative movement in the Y direction, and thus the recording head may move in the Y direction.

Further, the pressing member according to the above-described exemplary embodiments is a member having a width enough to wipe the ejection port surface in the X direction. Alternatively, the pressing member may have a width enough to wipe the ejection port surface in the Y direction, and the wiping operation may be performed by relative movement in the X direction. Further, the wiping unit may be disposed such that the cleaning member is wound up in the X direction, and the wiping operation may be performed by relative movement in the X direction.

As described above, the ejection port surface is wiped in the state where the particles each having the particle diameter greater than the diameter of each of the particles of the coloring material are present between the ejection port surface and the cleaning member, which makes it possible to prevent deterioration of the ejection port surface by the wiping operation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-007823, filed Jan. 21, 2020, which is hereby incorporated by reference herein in its entirety.

What is claimed is:

1. A wiping device comprising:
a cleaning member configured to perform wiping operation to wipe an ejection port surface of a recording head, wherein the recording head includes the ejection port surface on which an ejection port, for ejecting ink containing particles of a coloring material, is formed; and
a control unit configured to control the cleaning member to perform the wiping operation in a state where particles are imparted to a surface of the cleaning member, wherein the imparted particles are different in type from the coloring material particles and each imparted particle has a particle diameter greater than a diameter of each of the coloring material particles.

2. The wiping device according to claim 1, wherein the imparted particles are fine resin particles.

3. The wiping device according to claim 2, wherein the fine resin particles contain any of fine acrylic resin particles, fine acrylic-styrene resin particles, fine polyethylene resin particles, fine polypropylene resin particles, fine polyurethane resin particles, and fine styrene-butadiene resin particles, each resin particle having a particle diameter of 100 nm to 200 nm.

4. The wiping device according to claim 1, wherein the imparted particles are lower in hardness than the ejection port surface.

5. The wiping device according to claim 4, wherein the imparted particles each have hardness of R20 to R60 in Rockwell hardness.

6. The wiping device according to claim 1, wherein the imparted particles are lower in hardness than the coloring material contained in the ink.

7. The wiping device according to claim 1, wherein the recording head is subjected to treatment imparting water repellency or hydrophilicity to the ejection port surface.

8. The wiping device according to claim 1, wherein the cleaning member is made of a sheet web or a pad-like non-woven fabric obtained by bonding or intertwining fibers through fusion, mechanical action, or chemical action.

9. The wiping device according to claim 1, wherein the cleaning member is previously impregnated with the imparted particles.

10. The wiping device according to claim 1, further comprising a pressing member configured to press the cleaning member against the ejection port surface,
wherein the wiping operation is performed while the pressing member presses the cleaning member against the ejection port surface.

11. The wiping device according to claim 10, further comprising a supply unit configured to supply, to the pressing member, solution containing the imparted particles,
wherein the pressing member is made of a porous body,
wherein, before the ejection port surface is wiped, the cleaning member is impregnated with the imparted particles by coming into contact with the pressing member, and
wherein the cleaning member performs the wiping operation in a state where the cleaning member is impregnated with the imparted particles.

12. The wiping device according to claim 1,
wherein a plurality of ejection ports of the recording head, including the ejection port, is arranged in a predetermined direction, and
wherein the wiping operation is performed by relative movement of the recording head and the cleaning member in the predetermined direction.

13. The wiping device according to claim 1, further comprising:
the recording head; and
a conveyance unit configured to convey a recording medium.

14. The wiping device according to claim 1, further comprising a moving unit configured to move the cleaning member.

15. A wiping device comprising:
a cleaning member configured to perform wiping operation to wipe an ejection port surface of a recording head, wherein the recording head includes the ejection port surface on which an ejection port, for ejecting ink containing particles of a coloring material, is formed; and
a control unit configured to control the cleaning member to perform the wiping operation in a state where particles are imparted to the ejection port surface of the recording head, wherein the imparted particles are different in type from the coloring material particles and each imparted particle has a particle diameter greater than a diameter of each of the coloring material particles.

16. A method of wiping an ejection port surface, the method comprising:
moving a recording head to a position where an ejection port surface is wiped by a cleaning member, wherein the recording head includes the ejection port surface on which an ejection port, for ejecting ink containing particles of a coloring material, is formed; and
wiping the ejection port surface of the recording head in a state where particles that are different in type from the coloring material particles, and each have a particle diameter greater than a diameter of each of the coloring material particles, are imparted to a surface of the cleaning member.

17. A method of wiping an ejection port surface, the method comprising:
imparting particles to an ejection port surface of a recording head, wherein the recording head includes the ejection port surface on which an ejection port, for ejecting ink containing particles of a coloring material, is formed, and wherein the imparting particles are different in type from the coloring material particles and each has a particle diameter greater than a diameter of each of the coloring material particles; and
wiping the ejection port surface by a cleaning member in a state where the imparted particles, different in type from the coloring material particles, are imparted to the ejection port surface.

18. A method for a wiping device having a cleaning member, the method comprising:
performing wiping operation, via the cleaning member, to wipe an ejection port surface of a recording head, wherein the recording head includes the ejection port surface on which an ejection port, for ejecting ink containing particles of a coloring material, is formed; and
controlling the cleaning member to perform the wiping operation in a state where particles are imparted to a surface of the cleaning member, wherein the imparted particles are different in type from the coloring material particles and each imparted particle has a particle diameter greater than a diameter of each of the coloring material particles.

19. A method for a wiping device having a cleaning member, the method comprising:
performing wiping operation, via the cleaning member, to wipe an ejection port surface of a recording head, wherein the recording head includes the ejection port surface on which an ejection port, for ejecting ink containing particles of a coloring material, is formed; and
controlling the cleaning member to perform the wiping operation in a state where particles are imparted to the ejection port surface of the recording head, wherein the imparted particles are different in type from the coloring material particles and each imparted particle has a particle diameter greater than a diameter of each of the coloring material particles.

20. A non-transitory computer-readable storage medium storing a program to cause a computer to perform a method for a wiping device having a cleaning member, the method comprising:
performing wiping operation, via the cleaning member, to wipe an ejection port surface of a recording head, wherein the recording head includes the ejection port surface on which an ejection port, for ejecting ink containing particles of a coloring material, is formed; and
controlling the cleaning member to perform the wiping operation in a state where particles are imparted to a surface of the cleaning member, wherein the imparted particles are different in type from the coloring material particles and each imparted particle has a particle diameter greater than a diameter of each of the coloring material particles.
